(19) United States
(12) Patent Application Publication
(10) Pub. No.: US 2006/0161621 A1
(43) Pub. Date: Jul. 20, 2006

(54) System, method and computer program product for collaboration and synchronization of media content on a plurality of media players

(75) Inventor: Louis B. Rosenberg, Arroyo Grande, CA (US)

Correspondence Address: LAW OFFICE OF PHILIP A STEINER, 846 HIGUERA STREET, SUITE 11, SAN LUIS OBISPO, CA, 93401, US

(73) Assignee: Outland Research, LLC, Pismo Beach, CA (US)

(21) Appl. No.: 11/223,368

(22) Filed: Sep. 9, 2005

Related U.S. Application Data
(60) Provisional application No. 60/644,417, filed on Jan. 15, 2005.

(51) Int. Cl. G06F 15/16

(52) U.S. Cl. 709/204

(57) ABSTRACT

A system, method and computer program product is provided which facilitates the collaborative selection and synchronous playing of digital media on a plurality of networked media players. Various embodiments of the invention provides for a plurality of media players in processing communications which enables individual users of the media players to form a collaborative group; whereby the collaborative group of users may jointly suggest, approve, reject, vote, or otherwise select the media item to be synchronously played upon their individual media players. In some embodiments of the present invention, at least one of the media players is assigned a role of designated media coordinator. Each of the plurality of media players includes a processor, a communications infrastructure coupled to the processor, a secondary memory coupled to the communications infrastructure having retrievably stored therein one or more media items playable by the processor, a transceiver coupled to the communications infrastructure, a main memory coupled to the processor and at least one collaboration program stored in at least a portion of the memory. The collaboration program having instructions executable by the processor to exchange parameters among the individual media players to enable the collaborative selection and synchronous playing selected media items.

### CROSS-REFERENCE TO RELATED APPLICATIONS

This application is a non-provisional application claiming benefit and priority under 35 U.S.C. § 119(e) from applicant's co-pending U.S. provisional application Ser. No. 60/644,417, entitled, “A Method and System for Moderating Synchronized media content on Plurality of Individual Portable Media Players,” filed on Jan. 15, 2005, to the instant inventor; said provisional application identified by Ser. No. 60/644,417 is hereby incorporated by reference in its entirety.

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates generally to a collaboration arrangement, and more specifically to a system, method and computer program product for collaboratively and/or synchronously playing electronic media items between and among a plurality of media players.

### BACKGROUND

Electronic media players have become popular personal entertainment devices due to their highly portable nature and interconnectivity with existing computer networks, for example the Internet. The accessibility and simplicity in downloading music and other electronic media continues to fuel the popularity of these devices as is exemplified by Apple Computer, Inc.'s highly successful iPod™ portable media player. Other manufacturers have competing media players offering various functionalities and file playing compatibilities in an effort to differentiate their products in the marketplace.

As discussed in Apple Computer, Inc., patent application, US 2004/0224638 A1, Ser. No. 10/423,490 to Fadell, et al., which is herein incorporated by reference in its entirety; an increasing number of consumer products are incorporating circuitry to play music and other electronic media.

For example, many portable electronic devices such as cellular telephones and personal digital assistants (PDAs) include the ability to play electronic media in many of the most commonly available file formats including MP3, AVI, WAV, MPG, QT, WMA, AIFF, AU, RAM, RA, MOV, MIDI, etc.

By their very nature, these portable electronic devices are personal to a user, lacking the ability to allow users to collaboratively share media experiences. At best, a common headphone connection may be provided to allow another to listen to the electronic media playing on a media player. This arrangement physically restricts the users to a close proximity to the media usually defined by the length of the cord attached to the headphones.

Alternately, as suggested in the Fandell reference, the media players may be equipped with transceiver circuits which allow for the broadcasting of electronic media in real time from one media player acting as a media server to other media players acting as passive media clients. However, this broadcast arrangement raises copyright concerns as the direct transfer of copyrighted electronic media to multiple parties limits its usefulness to non-copyrighted works. Furthermore, the broadcast arrangement requires a significant amount of information to be transmitted to each of the media players which may increase the processing load upon the media player, significantly impair the useful battery life of media player, reduces available network bandwidth and is subject to unauthorized interception. Furthermore, this simple server-to-clients media broadcasting model provides no means for a group of users to collaboratively select, agree upon, or otherwise identify the media content to be played at any particular time. In fact, this simple client/server media broadcasting model relegates all client media players to mere passive receivers of media content with no more interactive input than if they were receiving a radio broadcast stream.

Therefore, a mechanism which allows a group of users to collaboratively and securely share an electronic media experience in concert without necessarily having to broadcast the actual electronic media to members of the group is highly desirable.

Additionally, a mechanism which allows a plurality of collaborating users to collectively suggest, select, reject, vote upon, or otherwise agree upon the media content to be played is highly desirable.

### SUMMARY

This invention provides various arrangements in which a plurality of users, each user in possession of a suitably configured media player, is enabled to share a collaborative media experience. The collaborative media experience allows each user of the plurality of media players to collaboratively select and experience media items as a participatory member of a collaborative group. In an embodiment of the present invention, each of the group members may takes turns selecting the media items to be played to the collaborative group as moderated by collaboration programs operatively installed in the media players.

In an embodiment of the present invention, the plurality of individual users may jointly select the media items to be played to the collaborative group, where the joint selection may be performed by a member voting process moderated by the collaboration programs. In various embodiments of the present invention, at least one media player of the plurality of media players may be designated as a media coordinator, where the designated media coordinator is assigned a more significant role in the selection of the media items than the other media players.

For example, the media coordinator media player may be enabled by the collaboration programs to suggest media items for the collaborative group, allowing each of the members to accept, reject, or vote upon the suggested media items. In various embodiments of the present invention each of members may take turns as a designated media coordinator, in which the turns are moderated by the collaboration programs. In an embodiment of the present invention the media players of the collaborative group are assigned a priority level.

The priority level may be used to enable certain group members to have greater influence over the collaborative selection of media items than other group members.

Other various embodiments of the present invention enable new users to permissively join a collaborating group with the approval of one or more of the existing members of the collaborating group.

In an exemplary systematic embodiment of the invention, a media collaboration system is provided which comprises a plurality of media players in processing communications with one another. Each media player includes a processor, a communications infrastructure coupled to the processor and a secondary memory coupled to the communications infrastructure. The secondary memory has retrievably stored therein one or more media items playable by the processor. Media items may include but are not limited to, for example, musical pieces represented as digital audio files.

The media players further comprise a transceiver coupled to the communications infrastructure; a main memory coupled to the processor. Various embodiments of the invention provides for at least one of a programmable timing circuit and synchronization information for synchronously playing the selected media item; a visual display coupled to the communications infrastructure; the visual display being configured to visually output text or graphics from the processor to a user; an audio subsystem coupled to the communications infrastructure, where in an one inventive embodiment, the audio subsystem is configured to receive aural responses input by the user and output audio signals to the user; and a user interface coupled to the communications infrastructure.

In an inventive embodiment, the user interface is configured to receive inputs from the user and output notices to elicit the user for inputs requested by the processor. The user interface includes at least one of a pointing device, a touch screen, a pushbutton, a sliding control, a radial control, a switch, and a tactile feedback unit.

The audio sounds provided by the audio subsystem arise from the playing media items and attention sounds generated by the processor to elicit user inputs in conjunction with the user interface.

At least one collaboration program is operatively installed in at least a portion of the main memory; the program having instructions executable by the processor to receive at least one parameter and synchronously play in concert but separately a selected media item retrieved from the secondary memory in at least partial dependence on the received at least one parameter with at least another media player.

Various inventive embodiments of the aforementioned collaboration program(s) provides that the at least one parameter includes a unique media identifier associated with the selected media item to be played and/or a reference time, a play start delay time, a play start signal, or a counter value for synchronously playing the selected media item.

Additional inventive embodiments of the collaboration program(s) provides the ability to determine the at least one parameter in dependence on the retrievably stored media item local to the processor; transmit the at least one parameter from one media player to at least another media player; transfer the role of the designated media coordinator to at least another of the plurality of media players; exchange individualized lists of available media item identifiers among the plurality of the media players; receive the individualized lists of available media identifiers and generate a common list of media identifiers available to the plurality of media players where in one inventive embodiment the common list of media identifiers comprises a select media group.

Other inventive embodiments of the collaboration program(s) provides for permissively allowing access to the select media group, where in one inventive embodiment, the access to the select media group is dependent at least in part on one of user authentication, account registration and payment of a fee. In another inventive embodiment, the collaboration program(s) allow for permissibly accepting the selected media item, rejecting the selected media item and/or the ability to suggest an alternative media item for synchronously playing among the plurality of media players. In a related inventive embodiment, the acceptance is dependent at least in part on one of a vote by users in possession of the plurality of media players. In a related embodiment of the invention, the vote is one of a majority, weighted, priority and unanimous.

Additional inventive embodiments of the collaboration program(s) provides for the designated media coordinator being dependent at least in part on one of a vote, a predetermined transfer sequence and at random designation.

Other inventive embodiments of the collaboration program(s) provides the abilities to remotely retrieve the selected media item if not locally present in the secondary memory, authenticate to a media provider to remotely retrieve the selected media item, signal the designated media coordinator when the selected media item is locally available, await a media play start signal before all the plurality of media players begin playing the selected media item, playing the selected media item by the plurality of media players in possession of the selected media item, and advancing to a synchronous point in time as those already playing the selected media item and begin playing the selected media item from the synchronous point in time and thereafter.

In a related embodiment of the invention, the processing communications is accomplished at least in part wirelessly over at least one of; a wireless network, a BlueTooth network, a cellular network and a satellite network.

In an exemplary methodic embodiment of the invention a media collaboration method is provided which comprises; providing at least one collaboration program operatively loadable into a memory of a plurality of media players; providing in the at least one collaboration program; a first function adapted to send at least one parameter from one media player to at least another media player; a second function adapted to retrieve from a local datastore associated with at least the another media player, a selected media item in dependence on the at least one sent parameter; and a third function adapted to synchronously play in concert but separately the selected media item between the one media player and at least the another media player.

In a related embodiment of the invention, a fourth function is provided which is adapted to allow a plurality of users in possession of the plurality of media players a collaborative decision-making ability.

In various embodiments of the invention, the collaborative decision-making ability includes one of suggesting an alternative media item, accepting the selected media item, collaboratively voting on the selected media item, suggesting at least one of the plurality of media players assumes a role of media coordinator, accepting the role of media coordinator, rejecting the role of media coordinator and collaboratively voting on which of the plurality of media players assumes the role of media coordinator.

In another related embodiment of the invention, a fifth function is provided which is adapted to retrieve the selected media item from a media provider if the selected media item is not present in the local datastore.

Access to the media provider may be accomplished by receiving a request from at least one user having an account with the media provider to retrieve the selected media item in dependence on the unique media identifier, and providing the selected media item to the requesting media player of the requesting user. The access to the media provider may further require authenticating the user before providing the selected media item and thereafter charging the requesting user's account for retrieving the selected media item.

In an exemplary computer program product embodiment of the invention, executable instructions disposed in a tangible form readable by a processor associated with a media player are provided to cause the processor to receive at least one parameter from a second processor, retrieve from a secondary memory coupled to the processor a selected media item in dependence on the at least one parameter, load the retrieved selected media item into a main memory coupled to the processor; and synchronously play the retrieved selected media in concert but separately with at least the second processor.

Various inventive embodiments of the aforementioned computer program product further comprise executable instructions for the processor to retrieve the selected media item from a third processor if not present in the secondary memory, advance to a synchronous point in time as the second processor and begin playing the selected media item from the synchronous point in time and thereafter, permissibly accept the selected media item or suggest an alternative media item for synchronously playing in concert but separately with at least the second processor, the acceptance is dependent at least in part on a vote received from at least the second processor.

In another related embodiment of the invention, the tangible form comprises magnetic media, optical media or logical media. In final related embodiment of the invention, the executable instructions are stored in a code format comprising one of byte code, compiled, interpreted, compliable and interpretable.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional components or feature are generally shown in dashed lines. It is intended that changes and modifications can be made to the described embodiment without departing from the true scope and spirit of the subject invention as defined by the claims.

FIG. 1—depicts a generalized block diagram of a media player.

FIG. 2—depicts an embodiment of the invention where a media coordinator is in processing communications with a plurality of media players.

FIG. 2A—depicts an embodiment of the invention where one of the media players is retrieving a media item selection using a typical network arrangement.

FIG. 2B—depicts an embodiment of the invention where one of the media players is retrieving a media item selection using a satellite network arrangement.

FIG. 2C—depicts an embodiment of the invention where a plurality of media players are collaborating to synchronously play a selected media item.

FIG. 3—depicts a first flow chart of an embodiment of the invention.

FIG. 3A—depicts a second flow chart of an embodiment of the invention

FIG. 3B—depicts a third flow chart of an embodiment of the invention.

### DETAILED DESCRIPTION

The invention provides a system, method and computer program product which allows a group of users to collaborate and separately synchronize the playing of electronic media on a plurality of media players. Where necessary, computer programs, routines and algorithms are envisioned to be programmed in a high level language, for example Java™ C++, C, C#, or Visual Basic™.

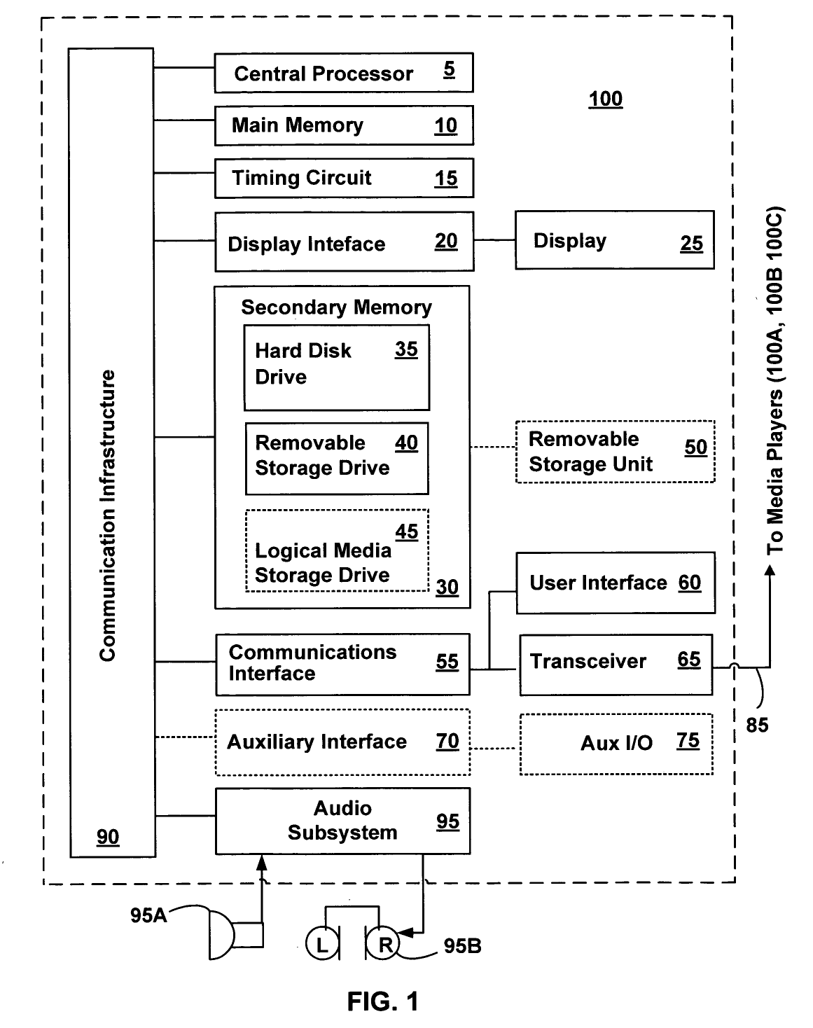

Referring to FIG. 1, a generalized block diagram of a media player 100 is depicted. The media player 100 includes a communications infrastructure 90 used to transfer data, memory addresses where data items are to be found and control signals among the various components and subsystems of the media player 100.

A central processor 5 is provided to interpret and execute logical instructions stored in the main memory 10. The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the media player 100. The central processor 5, main memory 10 and timing circuit 15 are directly coupled to the communications infrastructure 90.

A display interface 20 is provided to drive a display 25 associated with the media player 100. The display interface 20 is electrically coupled to the communications infrastructure 90 and provides signals to the display 25 for visually outputting both graphics and alphanumeric characters. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory subsystem 30 is provided which houses retrievable storage units such as a hard disk drive 35, a removable storage drive 40, an optional a logical media storage drive 45 and an optional removal storage unit 50.

The removable storage drive 40 may be a replaceable hard drive, optical media storage drive or a solid state flash RAM device. The logical media storage drive 45 may be flash RAM device, EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including, serial, parallel, USB, and Firewire connectivity. For example, a user interface 60 and a transceiver 65 are electrically coupled to the communications infrastructure 90 via the communications interface 55. For purposes of this disclosure, the term user interface 60 includes the hardware and operating software by which a user executes procedures on the media player 100 and the means by which the media player conveys information to the user.

The user interface 60 employed on the media play 100 includes a pointing device (not shown) such as a mouse, thumbwheel or track ball, an optional touch screen (not shown); one or more pushbuttons (not shown); one or more sliding or circular rheostat controls (not shown), one or more switches (not shown), and one or more tactile feedback units (not shown); One skilled in the relevant art will appreciate that the user interface devices which are not shown are well known and understood.

To accommodate non-standardized communications interfaces (i.e., proprietary), an optional separate auxiliary interface 70 and auxiliary I/O port 75 are provided to couple proprietary peripheral devices to the communications infrastructure 90.

The transceiver 65 facilitates the remote exchange of data and synchronizing signals between and among the various media players 100A, 100B, 100C in processing communications with 85 with this media player 100.

The transceiver 65 is envisioned to be of a radio frequency type normally associated with computer networks for example, wireless computer networks based on BlueTooth™ or the various IEEE standards 802.11.sub.x., where x denotes the various present and evolving wireless computing standards.

Alternately, digital cellular communications formats compatible with for example GSM, 3G and evolving cellular communications standards. Both peer-to-peer (PPP) and client-server models are envisioned for implementation of the invention. In a third alternative embodiment, the transceiver 65 may include hybrids of computer communications standards, cellular standards and evolving satellite radio standards.

Lastly, an audio subsystem 95 is provided and electrically coupled to the communications infrastructure 90. The audio subsystem is configured for the playback and recording of digital media, for example, multi or multimedia encoded in any of the exemplary formats MP3, AVI, WAV, MPG, QT, WMA, AIFF, AU, RAM, RA, MOV, MIDI, etc. The audio subsystem includes a microphone input port 95A and a headphone or speaker output port 95B. Connection of the microphone 85A and/or headset 95B includes both traditional cable and wireless arrangements known in the relevant art. As referred to in this specification, “media items” refers to video, audio, streaming and any combination thereof. In addition, the audio subsystem is envisioned to optionally include features such as graphic equalization, volume, balance, fading, base and treble controls, surround sound emulation, and noise reduction. One skilled in the relevant art will appreciate that the above cited list of file formats is not intended to be all inclusive.

The media player 100 includes an operating system, the necessary hardware and software drivers necessary to fully utilize the devices coupled to the communications infrastructure 90, media playback and recording applications and at least one collaborative program operatively loaded into main memory 10. Optionally, the media player 100 is envisioned to include at least one remote authentication application, one or more cryptography applications capable of performing symmetric and asymmetric cryptographic functions, and secure messaging software. Optionally, the media player 100 may be disposed in a portable form factor to be carried by a user.

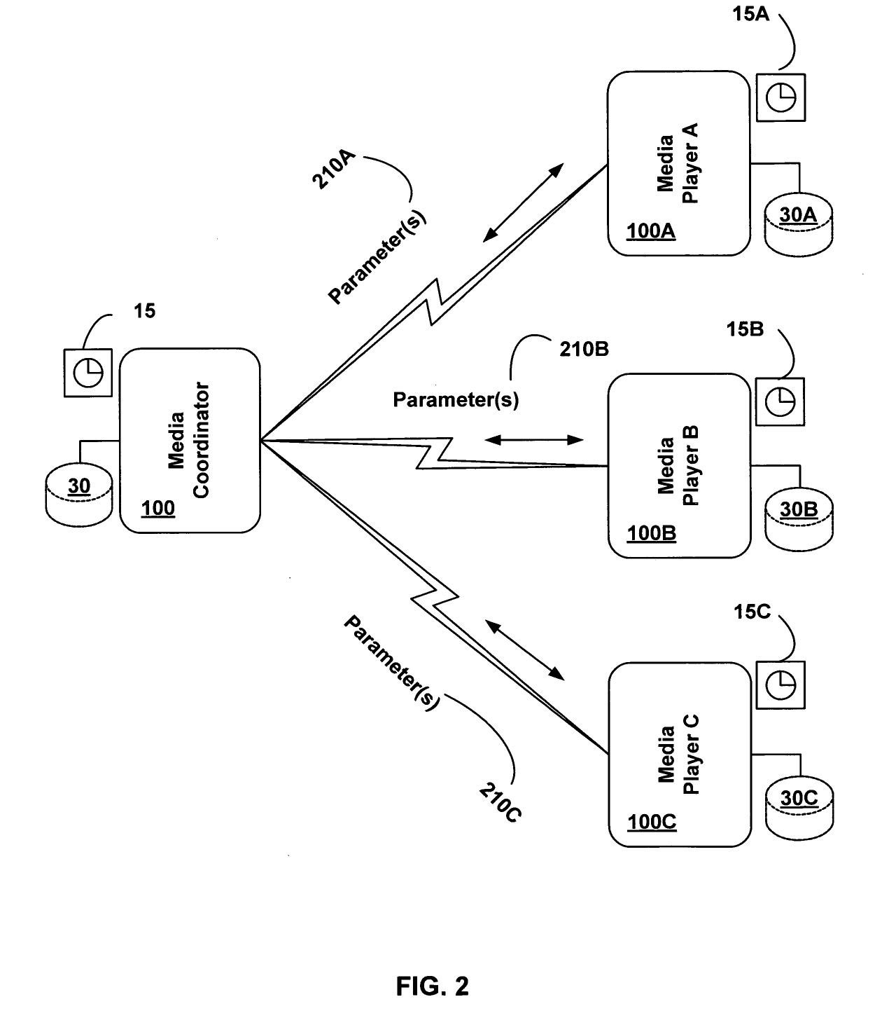

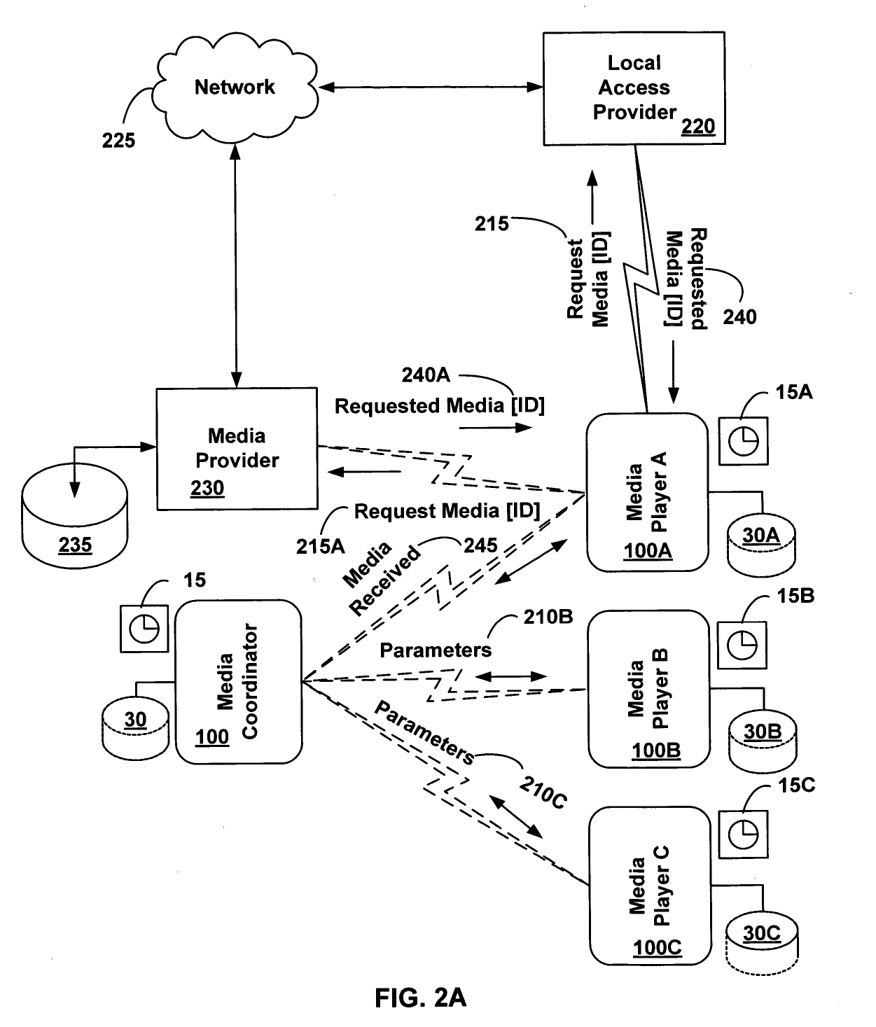

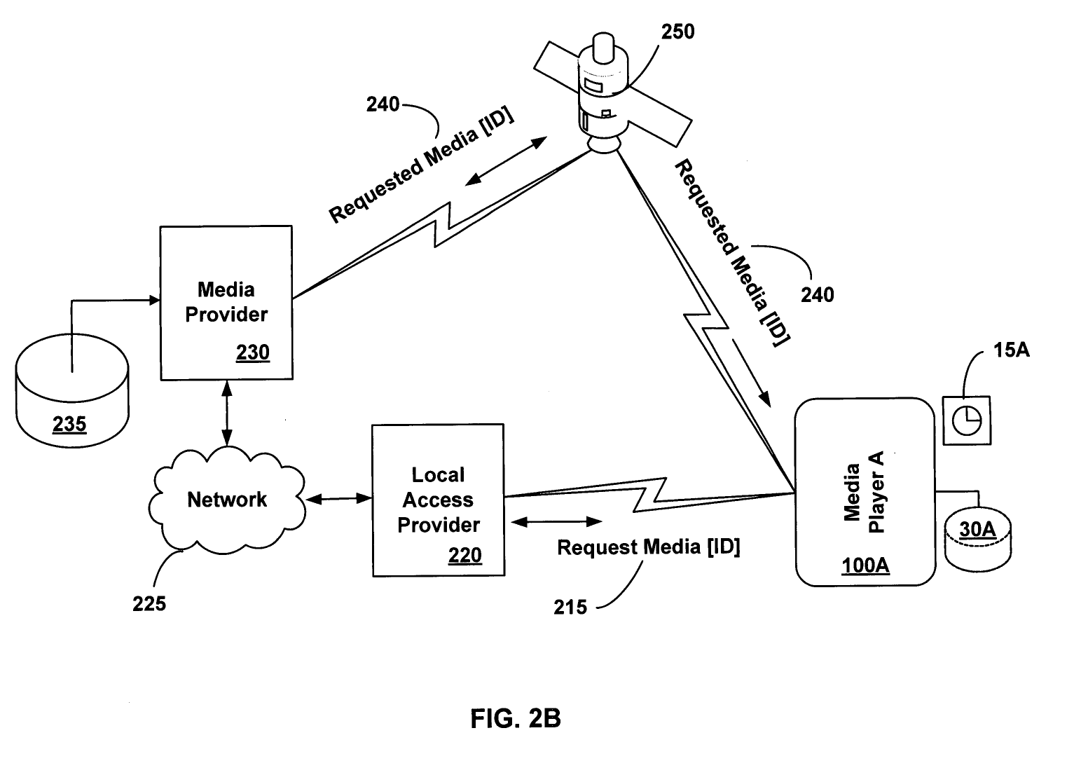

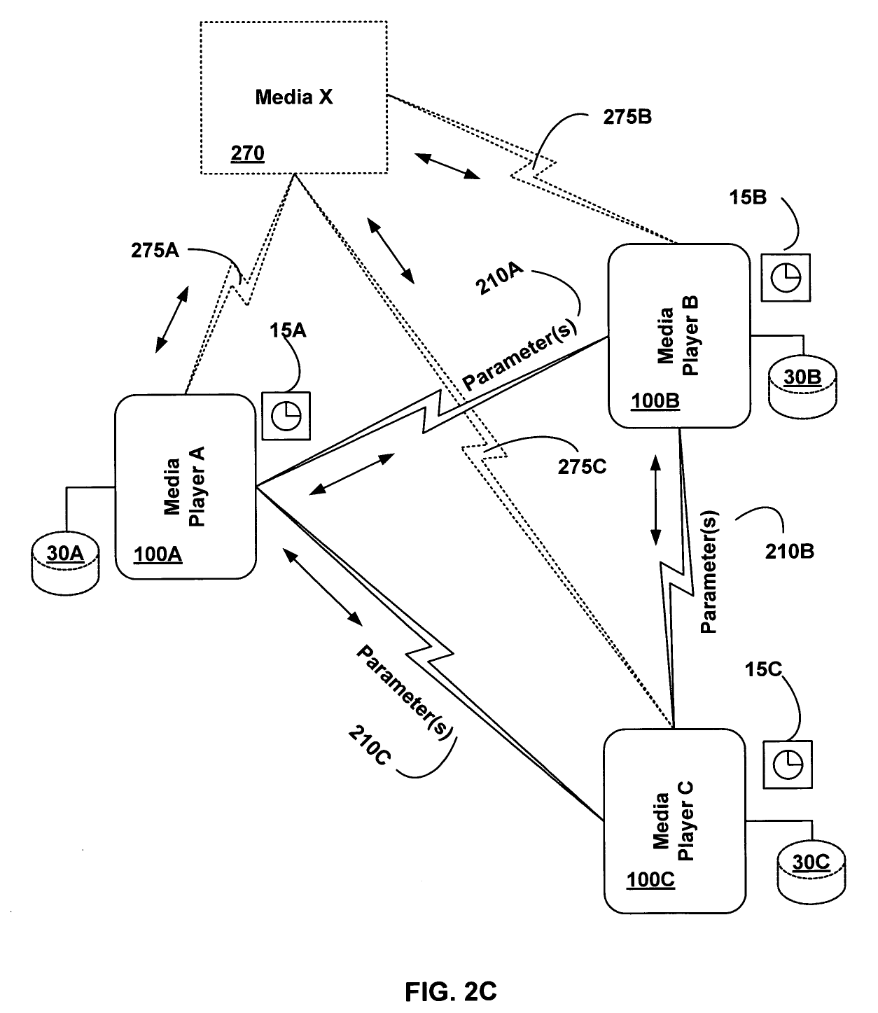

Referring to FIG. 2, an embodiment of the invention is depicted where a first media player is designated as a media coordinator 100 is in processing communications with three collaborating media players 100A, 100B, 100C.

Each media player 100, 100A, 100B, 100C includes a local datastore 30, 30A, 30B, 30C having media items stored therein. The stored media items may not be the same at each media player 100, 100A, 100B, 100C.

Additionally, each media player includes a timing circuit 15, 15A, 15B, 15C which is used to synchronize the playing of media items common to at least the media coordinator 100 and at least any one of the three collaborating media players 100A, 100B, 100C. In an embodiment of the invention, the media players 100, 100A, 100B, 100C include the ability to access an external timing circuit to synchronize its individual internal timing circuits 15, 15A, 15B, 15C to a standardized or reference time, thus ensuring that the plurality of media players 100, 100A, 100B, 100C have synchronously coordinated internal timing circuits. Alternately, each collaborating media player 100A, 100B, 100C may synchronize its timing circuits 15A, 15B, and 15C with the time circuit 15 of the associated with the media coordinator 100.

In an embodiment of the invention, the media coordinator 100 sends parameters 210A, 210B, 210C to each of the media players. In this embodiment of the invention, the parameters 210A, 210B, 210C includes a unique identifier for a suggested media item to be synchronously played. The actual media item to be played is not generally transmitted by the media coordinator 100.

Selection of the suggested media item to be played may be performed manually by a user performing the role of media coordinator 100, a random selection based on media items locally available in the datastore 30, sequential selection, a suggested alternative media item received from one or more of the collaborating media players 100A, 100B, 100C or by way of a collaborative vote.

In an embodiment of the invention, receipt of the incoming parameters triggers an alert to the user by providing a tactile, visual and/or audible alarm.

The alert indicates, for example, that one or more media item suggestions have been received from another media player. Furthermore the alert may include a visual and/or aural display of the title(s) and/or artist(s) of the one or more suggested media item selections. Furthermore the alert may include a display of the name, handle, or unique ID of the user(s) who suggested the one or more media item selections. The alert may require an action by the user, for example to accept or reject or vote upon the suggested media item selection(s), or if not responded to within a predefined time period, a default action is followed.

The default action may automatically accept or reject the suggested media item, or may cast a default vote for or against the suggested media item, or may waive the right to vote upon the suggested media items(s) in a current vote. Each collaborating media player 100A, 100B, 100C determines if the suggested media item is locally present in the datastore 30, 30A, 30B, 30C.

This determination may be performed using a simple lookup table which is locally maintained by each of the media players 100, 100A, 100B, 100C. In an embodiment of the invention, the play start time, play start delay, or play start signal for synchronously playing the suggested media item is received from the media coordinator along with the unique identifier. Internal timing circuits 15, 15A, 15B, 15C utilize the received synchronizing information and begin playing the media item as directed by the timing information. The timing circuit may incorporate an actual clock, a simple counter or a combination of a clock and an incremental or decremental counter.

The parameters 210A, 210B, 210C sent by the media coordinator 100 may include additional information including other timing information, media player settings (e.g., volume, tone, equalization, reference time, counter variable), request to transfer the media coordinator function to one of the collaborating media players 100A, 100B, 100C, individual identification or authentication information.

In an embodiment of the invention, the collaborating media player 100A, 100B, 100C acknowledges the received suggested media item. In an alternate embodiment of the invention, only the collaborating media player 100A, 100B, 100C which lacks the suggested media item responds to the media coordinator 100.

In an embodiment of the invention, the synchronous start time 15A, 15B, 15C for playing of the suggested media item is communicated by a subsequent transmission of parameters 210A, 210B, 210C from the suggesting media coordinator 100 to each of the collaborating media players 100A, 100B, 100C. For example, once a suggested media item has been voted upon by the collaborating media players, the votes are communicated to and tallied by the media coordinator 100. The media coordinator 100 then determines if the collaborative group of media players 100A, 100B, 100C has collectively agreed to play the suggested media item. If so, the media coordinator 100 sends an additional set of parameters 210A, 210B, 210C to the collaborating media players 100A, 100B, 100C indicating the synchronized start time 15A, 15B, 15C of the collaboratively agreed to media item selection. The synchronized start time 15A, 15B, 15C can be communicated as play upon receipt of the parameters, play after a designated time delay, or as play at a specific time in the future.

Alternately, if the collaborating media players 100A, 100B, 100C are currently playing a different synchronized media item selection, the start time 15A, 15B, 15C may be indicated as an amount of time after the current synchronized media item selection has completed playing.

Furthermore, if the collaborating media players 100A, 100B, 100C have additional pending media items which are already scheduled to play after the completion of the currently playing media item selection, the start time 15A, 15B, 15C may be indicated as an amount of time after the last of the currently pending media items has played.

In this way the system needs only synchronize a first media item selection in a series of media item selections and maintain synchronicity by having each of the collaborating media players play the series of media item selections in the same designated sequence with a same designated time delay between the media players 100A, 100B, 100C, if any. This should maintain synchronicity so long as additional selections are made prior to the completion of the currently pending items.

If additional selections are made after the completion of the currently playing and pending items (i.e. if there is a lull in the media playing), a new synchronizing time signal 15A, 15B, 15C is sent from the media coordinator 100 to the collaborating media players A, B, C 100A, 100B, 100C. Alternately, synchronizing time signals 15A, 15B, 15C may be sent periodically to ensure that the synchronization of the collaborating media players 100A, 100B, 100C does not drift apart substantially over time.

Referring to FIG. 2A, by way of example, a situation in which one of the media players 100A, 100B, 100C lacks a received suggested media item for playing is depicted. In this example, media player A 100A lacks the received suggested media item. To retrieve the missing media item, media player A 100A connects to a local access provider 220 and sends a request 215 to download the suggested media item. The request 215 is based on the unique identifier received from the media coordinator 100.

The local access provider 220 may be a wireless gateway way or cellular provider which couples the media player A 100A to a public network 225. The request 215 is routed to a media provider 230 where the requested media item is retrieved based on its associated media identifier from a datastore 235 associated with the media provider 230, routed over the network 225 to the local access provider 220 and downloaded 240 to media player A 100A.

The downloaded media item 240 is then operatively installed in the local datastore 30A of media player A 100A. In an embodiment of the invention, the media player A 100A signals 245 the media coordinator 100 that it is now ready to play the suggested media item. In response to the signal 245 received from media player A 100A, the media coordinator 100 sends updated playing parameters 210A, 210B, 210C to the media players 100A, 100B, 100C to synchronously play the suggested media item.

In this embodiment of the invention, media players B and C 100B, 100C wait for media player A 100A to receive the requested media item 240 before playing the suggested media item. In an alternate embodiment of the invention, media players B and C 100B, 100C do not wait for the requested media item 240 to be downloaded to media player A 100A.

In an embodiment of the present invention, when a media player, such as media player A 100A in the current example, lacks the suggested media item and the user of that media player decides to purchase that media item from a media provider 230, the media provider 230 may reward the user who suggested the media item for making a suggestion that resulted in a sale.

For example, the media provider 230 may assign units of credit to an account of the suggesting user in which the credit may be redeemable for additional media items.

In this alternate embodiment of the invention, media players B and C 100B, 100C, begin playing the suggested media item in dependence on the synchronization information received 210B, 210C or internally stored.

Once the requested media item 240 is downloaded and available to media player A 100A, media player A, using the originally provided synchronization information, advances ahead to a point in the media item which corresponds to the elapsed time between the initial start time and actual start time for media player A 100A, thus synchronizing media players A, B and C 100A, 100B, 100C and optionally with the media coordinator 100.

In another embodiment of the invention, the media player A 100A establishes a direct wireless connection with the media provider 230. In this embodiment of the invention, the request for media item 215A, again based on the media item's unique identifier, is sent directly to the media provider 230, retrieved from a datastore 235 associated with the media provider 230 and downloaded 240A directly to media player A 100A. All other aspects of this embodiment of the invention remain the same as previously described.

Referring to FIG. 2B, another embodiment of the invention is depicted which continues the example embodiment provided in the discussion for FIG. 2A.

In this embodiment of the invention, media player A 100A lacks the suggested media item as before and connects to the local access provider 220 and sends a request 215 to download the suggested media item.

The request 225 is routed to a media provider 230 over the public network 225 where the requested media item is retrieved from a datastore 235 associated with the media provider 230. However, rather than returning the requested media 215 via the public network 225 and local access provider 220, the requested media 240 is transmitted by an earth station (not shown) to a satellite which then downloads the requested media item to media player A 100A.

This embodiment of the invention is intended to take advantage of the digital broadcast capabilities of the latest generation of satellite broadcast providers (e.g., XM™, Sirius™.)

The broadcast capabilities of the satellite providers have ample capacity either directly in a main carrier or a sub channel to download the requested media item at high data rates, thus minimizing the waiting time associated with large file transfers occurring over wireless networks. All other aspects of this embodiment of the invention remain the same as previously described.

Referring to FIG. 2C, an embodiment of the invention is depicted where a plurality of media players 100A, 100B, 100C are in processing communications with at least another media player to collaboratively play a selected media item. The selection of the media item may be performed as before where one of the media players 100A suggests a media item to be played by the other two media players 100B, 100C. The suggested media item to be played is exchanged between the three media players using one or more parameters 210A, 210B, 210C. In this embodiment of the invention, each user associated with the media players may accept, reject, suggest an alternative media item selection or submit to a vote regarding the media item suggested by media player A 100A. The collaborative media decision-making is performed by media player A 100A using the information contained in the exchanged parameters 210A, 210B, 210C as previously described.

Additional collaborative decision-making information, such as designating the role of media coordinator 100 (FIG. 2), synchronizing information 15, 15A, 15C, 15C (FIG. 2) may also be included in the exchanged parameters 210A, 210B, 210C.

In an embodiment of the invention, one or more media players Media X 270 not originally part of the collaborating group of media players A, B or C 210A, 210B, 210C may join the collaboration by requesting access 275A, 275b, 275C to the group of collaborating media players 210A, 210B, 210C. The request(s) 275A, 275B, 275C may be directed to one or more of the entire collaborating group of media players 210A, 210B, 210C.

Allowance into the collaboration session may be performed for example by vote, preestablished accounts, or priority over existing collaborating media players 210A, 210B, 210C.

In an alternate embodiment of the invention, Media X 270 represents a media provider which may for example be delivering selected media item to one or more of the collaborating media players 100A, 100B, 100C. The media item refers to both file transfers and accessing of streaming media item(s) which is collaboratively selectable; thus allowing each user associated with the media players 100A, 100B, 100C to accept, reject, suggest an alternative media item selection or submit to a vote regarding the media item suggested by for example, by media player A 100A.

In an embodiment of the invention where Media X 270 functions as a media provider, Media X 270 may be enabled to retain user specific preferences based on media item selections requested by one or more of the media players 100A, 100B, 100C. The user specific preferences may be used by Media X 270 to heuristically determine other media item selections for suggestion to the users of the media players 100A, 100B, 100C, the playing of the suggested media items being determinable by a collaborative decision-making process by the users as disclosed herein. For example, the users may cast votes as to their acceptance of the suggested media items and thereby collaboratively deciding whether or not the suggested media item(s) are to be played by the collaborative group.

One skilled in the relevant art will appreciate that the parameters 210A, 210B, 210C may be communicated between and among the media players A, B or C 210A, 210B, 210C, MC 210, Media X 270, Local Access Provider 220, and media provider 230 using well established communications methods including but not limited to incorporating the parameters 210A, 210B, 210C in a message packet, digital certificate, text string, applications protocol data unit (APDU), binary signal, etc., generally defined by the communications protocol employed.

References made in this specification to messaging, signaling, communicating, transmitting, sending, receiving, submitting suggesting, exchanging, notifying, alerting, voting, etc. should be construed in light of the relevant art regarding digital communications, such as communications involving data transfer from one computer to another through a communications medium without regard to a particular format, data structure or communications protocol.

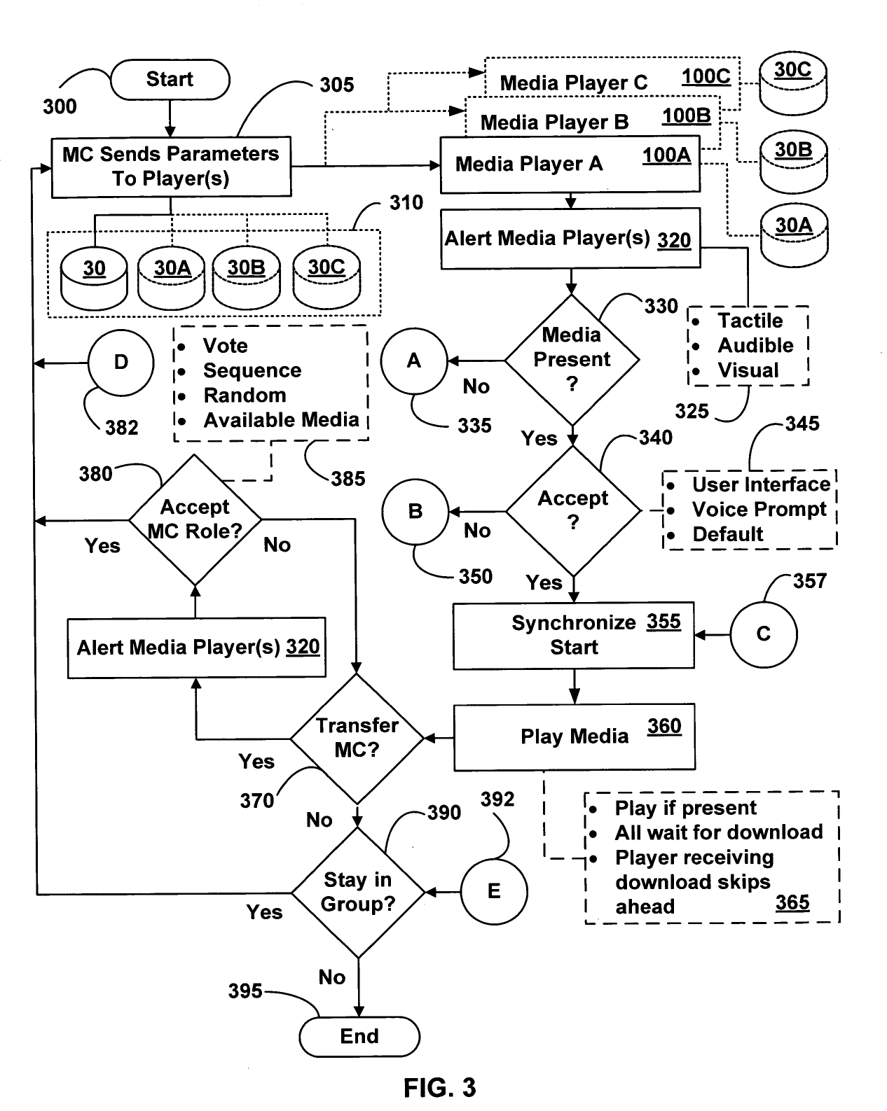

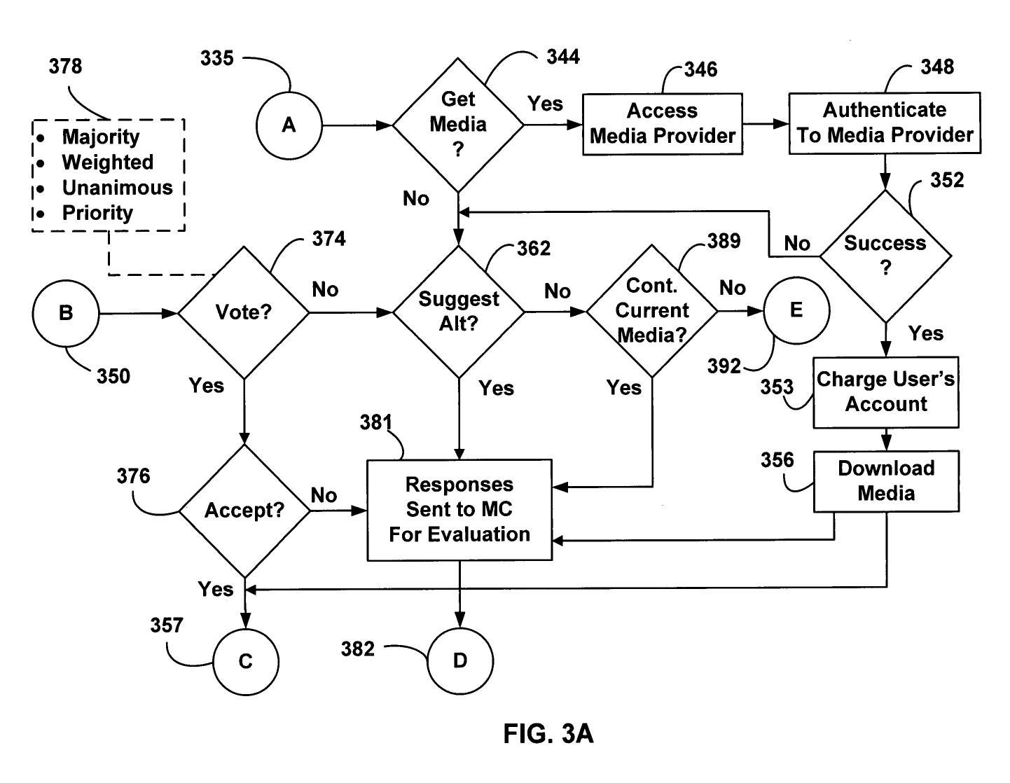

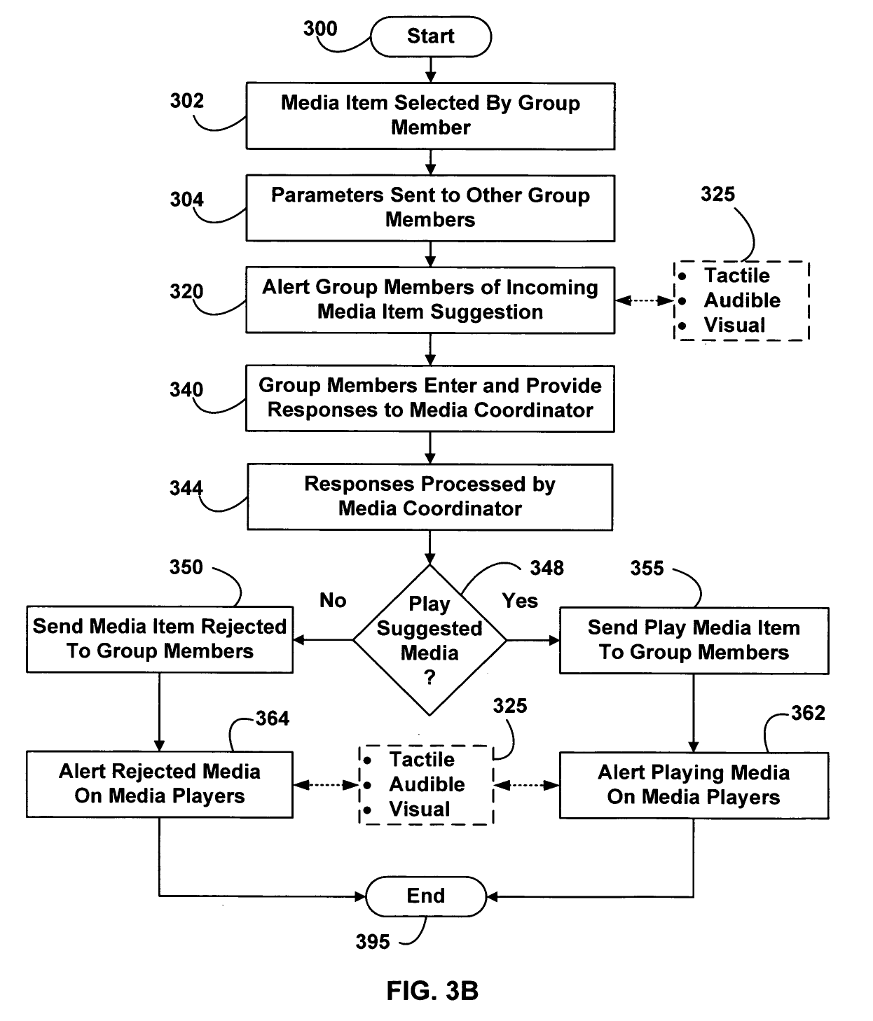

Referring to FIG. 3, a flow chart of several embodiments of the invention is depicted. The process is initiated 300 when the media coordinator (MC) sends parameters to each of the media players 305. The parameters include a unique identifier associated with a media suggested to be played synchronously among the media players 100A, 100B, 100C. The suggested media item to be played is determined in part by media available in a data store 30 associated with the MC. In an alternate embodiment of the invention, the MC maintains lists 30, 30A, 30B, 30C of the media items available to each of the media players 100A, 100B, 100C. Access to the lists of media items may be made on a group basis or by individual authentication to the MC.

The receipt of parameters by the media players 100A, 100B, 100C triggers an alert 320 to be generated which notifies the user of an incoming message from the MC. The alert 320 may be provided in tactile, audible, and/or visual form 325.

Each media player 100A, 100B, 100C, determines if the suggested media item 330 is present on its associated data store 30A, 30B, 30C.

If the media item is present 330, each user associated with the media players 100A, 100B, 100C is provided the opportunity to accept 340 the suggested media item. Acceptance may be provided for example, by manually entering a response into the user interface associated with the media players 100A, 100B, 100C, by voice response, or by a predetermined default response 345.

If the suggested media item is not present 300, additional processes may be invoked 335 which are continued at marker A in the discussion accompanying FIG. 3A. Likewise, if one or more users do not accept the suggested media item 340, another set of processes may be invoked 350 which are continued at marker B in the discussion accompanying FIG. 3A.

If a majority of the users accept the suggested media item 340, the suggested media item to be played is retrieved from the datastores 30A, 30B, 30C, associated with the media players and are synchronized to begin playing at a synchronized time 355. The time synchronization may be performed by way of a default start time, receipt of a reference time, receipt of a delay time, receipt of a start signal, or receipt of a counter variable. The start time and counter variable are sent in an embodiment of the invention along with the media identifier as part of the parameters 305. Although majority acceptance is used in this example for determining the playing of said media item, other embodiments such as unanimous acceptance and/or acceptance of above a certain percentage may be employed.

The synchronized media item is played 360 in concert but separately at each of the media players in possession of the suggested media item. In the event that one or more of the media players lacks the suggested media item, the remaining media players may begin playing the media item in dependence with the synchronization information or awaits the downloading of the suggested media item to the media players lacking the suggested media item 365.

In an embodiment of the invention, an option is provided to permissively transfer the role of MC 370 and/or permissively exit the collaborative group 390. To transfer the role of MC 370, the current user acting as MC 370 may for example select an appropriate option via the user interface of the user's media player.

Alternately, the user may be prompted to transfer the MC 370 role, for example when a certain time period has elapsed or when a certain number of media item selections have been played. In some embodiments the user is forced to transfer the role at certain predefined intervals. In other embodiments the transfer is optional. In some embodiments the transfer is dependent upon a vote of users in the collaborative group.

If the current MC chooses to transfer the role of MC 370, the MC alerts the media players 320 as described above and attempts to transfer the MC role to another designated media player 380.

If the next designated media player declines 380 to accept the MC role, the current MC may then attempt to transfer the MC role to another media player 380. Transfer of the MC 370 role may be accomplished by a vote, sequential order, random selection, or by available media items 385. If the next designated media player accepts the MC role 380, the process continues by the new MC 370 sending parameters to each of the media players 305 as previously described. Analogously, if the current MC desires to maintain the role of the MC 370, an embodiment of the invention provides the option for the current MC to continue the MC 370 role by electing to stay in the current collaborative group 390. However, if the current MC 370 is either unable to transfer the role of MC and/or no longer wishes to remain in the synchronized collaborative group, the user may elect to withdraw from the group 390 thus ending the synchronized session for this user 395.

Referring to FIG. 3A, a continuation of the process flow chart of FIG. 3 is depicted. In the event that one or more of the media players lack the suggested media item continued at marker A 335, an embodiment of the invention provides an option to retrieve the missing media item 344. If a user of a particular media player chooses to retrieve the missing media item 344, the media player attempts to access a media provider 346.

In an embodiment of the invention, the user via a user interface associated with the media player, attempts to authenticate to the media provider 348. If the authentication is successful, 352 a preestablished user account is charged 353 and the requested media item is downloaded to the requesting media player 356.

In an embodiment of the invention, a message is communicated to the MC as to the successful downloading 381 of the suggested media item. The process continues at marker C 357 on FIG. 3, by synchronizing the start time 355 as previously described in the discussion accompanying FIG. 3.

Alternately, if the user is unsuccessful in authenticating to the media provider 352, the user of the media player lacking the suggested media item is provided with the option of suggesting an alternate media item 362. If the user of the media player decides to suggest an alternate media item 362, the suggested alternate media item is sent to the MC 381 where the suggested alternate media item is communicated to the remaining media players by continuing the process at marker D 382 of FIG. 3.

In the event that the user of the media player prefers to continue the playing of the current media item 389, the user's preference is communicated to the MC for evaluation 381 and continuation of the process at marker D 382 of FIG. 3.

Alternately, if the user of the media player does not want to continue playing the current media item 389, the user is provided with an option of withdrawing from the collaborating group of media players 392 as is continued at marker E 392 on FIG. 3. In an embodiment of the invention, a message is communicated to the MC 381 indicating the user's desire to withdraw from the collaborating group of media players.

In an embodiment of the invention, if one or more users of the media players do not accept the suggested media item continued from marker B 350 on FIG. 3, the playing of the suggested media item may be subjected to a vote by members (users) of the collaborative group 374. The votes are sent to the MC 381 as shown at marker D 382 on FIG. 3, for tallying and determination. The vote may be a simple majority, weighted, scaled, based on an assigned member priority or unanimous in nature 378.

If the collaborative group members vote 374 to reject 376 the suggested media item, the MC may suggest another media item and the process repeats as continued from marker D 382 on FIG. 3. Alternately, if the collaborative group members vote 374 to accept 376 the suggested media item, the processing continues as shown at marker C 357 on FIG. 3.

Referring to FIG. 3B, a flow chart depicting a simplified an exemplary collaborative process of the present invention is provided. The collaborative process enables a group of users, each using their own media players, to participate in the selection and experience media items as a synchronized collaborative group.

The process is initiated 300 when a first media player selects a media item to be suggested for synchronous play by a collaborative group 302. In this example embodiment, the suggesting media player 302, by the participatory act of suggesting the media item, becomes a media coordinator (MC) as provided in the discussions provided above for FIGS. 3 and 3A. The user of the first media player selects a media item from a list of available media items stored within a local memory of his or her media player and indicates through the user interface that the selected media item is to be suggested for synchronous play by the collaborating group.

In response to the user input, parameters are sent to each media player of the collaborative group 304. In this exemplary embodiment, the parameters comprise an indication of the suggested media item. In response to the receipt of the parameters, an alert is generated at each receiving media player 320. The alert may optionally be displayed by the interface of each of the other media players and/or be provided in visual, aural, and/or tactile 325 forms. Alternately or in addition thereto, the alert 320 may include an indication of the suggesting user, a title associated with the suggested media item, the artist, author, director, producer of the suggested media item, and/or an image associated with the suggested media item such as an album cover.

Each member of the collaborative group is given an opportunity to respond to the suggested media item by interacting through the interface of his or her respective media player 340. In an embodiment of the invention, if a collaborative group member does not respond within a certain amount of time, a default response is communicated to the MC and/or is assumed by the MC. In an embodiment of the invention, the default response may be preprogrammed as an acceptance, a rejection, a vote in favor or a vote rejecting the suggested media item.

Alternately, if a member chooses to respond within the established response time period, the user indicates his or her response (accept, reject, vote, subjective rating level) to the suggested media item through the user interface of his or her respective media player. The response may be provided, as a manual and/or vocal interaction with the user interface of the user's media player.

The response provided by each user to his or her media player is communicated as one or more response parameters sent from each of the media players to the MC 340. The response parameters may only include an indication of acceptance, rejection, vote, and/or subjective rating level. The response parameters may also include an identifier that indicates from which media player and/or which user the response(s) were provided. The response parameters may also include an identifier that indicates for which suggested media item the response was provided.

The responses provided by the collaborative group are sent to the acting MC for processing and determination 344. The MC determines based upon the received response parameters whether or not the collaborative group has collectively accepted or rejected the suggested media item 348. The determination may be based upon a variety of mechanisms for tallying the responses received from the media players. The responses may be tallied as equally weighted or weighted based upon a priority level assigned to each of the media players in the group. The responses may also be weighted based upon the order in which they were received and/or the time, at which they were received by the MC, the responses received first, for example, being assigned a higher weighting factor.

In one embodiment of the invention, acceptance may be based upon a majority of votes being tallied that are in favor of the suggested media item. In another embodiment the acceptance may be based upon a determination that a tally of the favorable votes exceeds a certain level or percentage. In yet another embodiment, the tally may include a count of the default responses for members who did not respond within an allotted time.

The MC may also determine and/or compute an acceptance level which indicates the tallied level of acceptance indicated by the group. The acceptance level may be used in future steps to determine the ordering of play of a plurality of accepted media items.

If the MC determines in that the suggested media item is rejected 348, a message may be sent to each media player 350 alerting the collaborative group members that the suggested media item has been collaboratively rejected 364. As previously discussed, the alert may be in the form of visual, aural and/or tactile 325.

In an embodiment of the invention, the alert message may include an indication of the computed vote tally and/or an indication of how some or all of the participating users responded to the suggested media item. In another embodiment, no alert message is sent to the collaborative group and processing ends 395 until another suggested media item is presented to the collaborative group 302.

If the MC determines 348 that the suggested media item is accepted, a message including one or more parameters is sent from the MC 355 to the other media players alerting the users and/or media players that the accepted media item should be played 362. The playing of the accepted media item may be immediately, at some time delay in the future, at some reference time in the future, or some time delay after other pending media items have been played. In another embodiment of the invention, a list of pending media items is maintained for the collaborative group.

Such a collaborative group play list may be maintained only by the MC media player or may be maintained simultaneously by each of the media players. In this embodiment of the invention, the MC includes in the alert message 355, one or more parameters instructing the media players to play the accepted media item at some point in the future. The one or more parameters may include synchronizing information such that the media players of the collaborative group will play the accepted media item in concert but separately. Once the accepted media item has been played, processing ends 395 until another suggested media item is presented to the collaborative group 302.

It is envisioned by the inventor that the timing as to when the suggested media item is played may be dependent upon a number of factors including the synchronizing information received from the MC and/or the presence of previously pending media items to be played. For example, if no other media item are currently playing or currently pending, the plurality of media players will play the new media item immediately or as otherwise indicated by the timing information received from the MC.

Alternately, if another media item is currently playing, the plurality of media players will play the new media item immediately after the current media item finishes playing or some time delay thereafter as indicated by synchronizing information received from the MC.

Thirdly, if a plurality of pending media items is stored within in a collaborative group play list, the newly accepted media item will be added to the end of list. In various related embodiments of the invention, the newly accepted media item may be added elsewhere in the list, for example ahead of some or all pending media items depending upon the priority level of the suggesting member, the priority levels of the voting members, and/or the acceptance level that was evaluated in response to the suggestion of that media item.

Additionally, there are a number of related embodiments which may be enabled that allow users to collaboratively select media items. These different embodiments may be used alone or in combination. Examples of some of these different embodiments are described as follows:

Unrestricted: In an unrestricted selection embodiment of the present invention any member of the collaborative group may suggest a media item for the collaborative group by interacting with the user interface upon his or her portable media player.

Upon selecting a media item to be suggested, the portable media player of the selecting member sends a message including at least one parameter indicating the selected media item to a designated MC or the portable media acts as the MC itself.

Priority Restricted: As mentioned previously, different members of the collaborative group may be assigned different priority levels. In some embodiments of the present invention, only members who have a priority level above a certain value are allowed to suggest media items for the group.

MC Restricted: In some embodiment of the present invention, the designated MC is the only member enabled to suggest media to be played to the collaborative group. A number of different methods may be employed to vary the designated MC as described previously. In some embodiments only members with priority levels above a certain value are given a turn as MC.

With respect to membership in a collaborative group, a variety of methods may be used to enable users to join and/or exit a collaborative group and optionally be assigned a priority level. In some embodiment a user may join a collaborative group by accessing the network that enables communication among the plurality of media players and indicating through the user interface a desire to join the group. In an embodiment of the invention, a user must also supply a password, credential, and/or a recognized personal identifier (biometric sample) in order to be admitted. In another related embodiment of the invention, a new user may request to join a collaborative group but may not be admitted unless one or more existing members of the collaborative group agree to the admission through a collaborative vote. In other embodiments of the invention, a priority level is assigned to users upon joining, optionally based upon the vote, the priority level affecting the user's ability to influence the collaborative decision-making of the group.

With respect to exiting a collaborative group, there are a number of mechanisms that may be employed by the present invention. In an embodiment, a user may exit a collaborative group by simply indicating through the user interface of that user's media player that the user wishes to exit the collaborative group as described in the discussion accompanying FIG. 3.

Alternately, a user may be automatically terminated from a collaborative group as a result of inactivity and/or failure to respond to a certain number of requests for input and/or failure to respond to requests for input for more than a certain amount of time.

In another embodiment, a user may be ejected from a collaborative group as a result of request(s) made by other members of the group, for example a majority of members casting votes indicating that the member should be ejected from the collaborative group.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. No specific limitation is intended to a particular security system or financial services system. Other variations and embodiments are possible in light of above teachings, and it is not intended that this Detailed Description limit the scope of invention, but rather by the Claims following herein.

1. A media collaboration system comprising:
a plurality of media players in processing communications with one another, each of said plurality of media players including;
a processor;
a communications infrastructure coupled to said processor;
a secondary memory local to said media player and coupled to said communications infrastructure having retrievably stored therein a plurality of media items playable by said processor;
a main memory coupled to said processor; and,
at least one collaboration program stored in at least a portion of said main memory having instructions executable by said processor to;
send at least one parameter from one media player to at least another media player; retrieve from said secondary memory of at least said another media player, a selected media item from said plurality of media items in at least partial dependence on said at least one sent parameter; and,
synchronously play said selected media item in concert but separately on at least said one media player and said at least another media player.

2. The system according to claim 1 wherein said at least one parameter includes a unique media identifier associated with said selected media item to be retrieved from said secondary memory.

3. The system according to claim 1 wherein at least a portion of said plurality of media players are disposed in a portable form factor.

4. The system according to claim 1 wherein said at least one parameter further includes synchronization information for synchronously playing said selected media item.

5. The system according to claim 4 wherein said synchronization information includes at least one of; a play start time, a play delay time, and a play start signal.

6. The system according to claim 1 wherein said at least one collaboration program further includes instructions executable by said processor to;
establish a hierarchy among at least a portion of said plurality of media players wherein at least one of said plurality of media players fulfils a transferable role of a designated media coordinator in which said designated media coordinator sends said at least one parameter to at least said another media player.

7. The system according to claim 6 wherein said at least one collaboration program further includes instructions executable by said processor to;
determine said at least one parameter to be exchanged with at least said another media player in at least partial dependence on said plurality of media items locally stored in said secondary memory of said designated media coordinator.

8. The system according to claim 1 wherein said at least one collaboration program further includes instructions executable by said processor to;
exchange individualized lists of available media item identifiers among said plurality of said media players; and,
generate a common list of media identifiers available to said plurality of media players, wherein said common list of media identifiers defines a select media group.

9. The system according to claim 8 wherein access to said select media group is permissively granted in at least partial dependence on one of; a collaborative vote, a user authentication, an account registration and a payment of a fee.

10. The system according to claim 9 wherein said vote is one of a majority vote, a weighted vote, a priority vote and a unanimous vote received by said designated media coordinator from at least a portion of said plurality of media players.

11. The system according to claim 6 wherein transfer of said designated media coordinator role to another of said plurality of media players is dependent at least in part on one of; a collaborative vote, a predetermined transfer sequence, a predetermined time duration, a predetermined priority and a random selection.

12. The system according to claim 1 wherein said at least one collaboration program further includes decisional instructions executable by said processor to perform at least one of; acceptance, rejection and collaborative vote upon a suggested media item received from at least another of said plurality of media players.

13. The system according to claim 12 wherein said vote is one of; a majority vote, a weighted vote, a priority vote, and a unanimous vote.

14. The system according to claim 1 wherein said at least one collaboration program further includes instructions executable by said processor to remotely retrieve said selected media item if not locally present in said secondary memory of at least said another media player.

15. The system according to claim 14 wherein said at least one collaboration program further includes instructions executable by said processor to await a play start signal before synchronously playing said selected media item.

16. The system according to claim 14 wherein said at least one collaboration program further includes instructions executable by said processor to;
advance to a synchronous point in time as those of said plurality of media players already playing said selected media item; and,
begin playing said selected media item from said synchronous point in time and thereafter.

17. The system according to claim 1 wherein at least a portion of said processing communications is accomplished wirelessly over at least one of; a wireless network, a BlueTooth network, a cellular network and a satellite network.

18. A media collaboration method comprising:
providing at least one collaboration program operatively loadable into a main memory of a plurality of media players;
providing in said at least one collaboration program, a first function adapted to send at least one parameter from one media player to at least another of said plurality of media players;
providing in said at least one collaboration program a second function adapted to retrieve from a local datastore associated with at least said another media player, a selected media item in at least partial dependence on said sent parameter; and,
providing in said at least one collaboration program a third function adapted to synchronously play said selected media item in concert but separately on at least said one media player and said at least another media player.

19. The method according to claim 18 further providing in said at least one collaboration program, a fourth function adapted to allow a plurality of users in possession of said plurality of media players a collaborative decision-making ability.

20. The method according to claim 19 wherein said collaborative decision-making ability includes at least one of; suggesting an alternative media item, accepting said selected media item, rejecting said selected media item and collaboratively voting on said selected media item.

21. The method according to claim 20 wherein said collaborative decision-making ability further includes at least one of; accepting said suggested alternative media item, rejecting said suggested alternative media item and collaboratively voting on said suggested alternative media item.

22. The method according to claim 19 wherein said collaborative decision-making ability includes one of; suggesting at least one of said plurality of media players assumes a role of media coordinator, accepting said role of media coordinator, rejecting said role of media coordinator and collaboratively voting on which of said plurality of media players assumes said role of media coordinator.

23. The method according to 20 wherein said synchronous play of said selected media item is based at least in partial dependence on a result of said collaboratively voting.

24. The method according to claim 19 further providing in said at least one collaboration program; a fifth function adapted to retrieve said selected media item from a media provider if said selected media item is not present in said local datastore.

25. The method according to claim 24 wherein access to said media provider includes;
receiving a request from at least one user having an account with said media provider to retrieve said selected media item in at least partial dependence on said unique media identifier; and,
providing said selected media item to said requesting media player associated with said at least one user.

26. The method according to claim 25 wherein access to said media provider further includes authenticating said at least one user before providing said selected media item.

27. The method according to claim 25 further including charging said account.

28. The method according to claim 20 wherein said collaborative decision-making ability further includes generating a result of said collaboratively voting to determine if said selected media item is to be played by said plurality of media players.

29. A computer program product embodied in a tangible form comprising executable instructions for a processor associated with a media player to;
receive at least one parameter from a second processor;
retrieve from a secondary memory coupled to said processor a selected media item at least in partial dependence on said received at least one parameter;
load said retrieved selected media item into a main memory coupled to said processor; and,
synchronously play said retrieved selected media item in concert but separately with at least said second processor.

30. The computer program product according to claim 29 further comprising executable instructions for said processor to retrieve said selected media item from a third processor if not present in said secondary memory.

31. The computer program product according to claim 30 further comprising executable instructions for said processor to advance to a synchronous point in time as said second processor and begin playing said selected media item from said synchronous point in time and thereafter.

32. The computer program product according to claim 30 further comprising executable instructions for said processor to permissibly accept said selected media item or suggest an alternative media item for synchronously playing with at least said second processor.

33. The computer program product according to claim 32 wherein said accept is dependent at least in part on a vote received from at least said second processor.

34. The computer program product according to claim 30 wherein said tangible form comprises at least one of; magnetic media, optical media or logical media.
